(19) United States
(12) Patent Application Publication
(10) Pub. No.: US 2010/0005640 A1
(43) Pub. Date: Jan. 14, 2010

(54) SCRIVET FASTENER REMOVAL TOOL

(76) Inventor: David Graham Fuller, Gastonia, NC (US)

Correspondence Address: ADAMS INTELLECTUAL PROPERTY LAW, Suite 2350 Charlotte Plaza, 201 South College Street, CHARLOTTE, NC, 28244, US

(21) Appl. No.: 12/501,065

(22) Filed: Jul. 10, 2009

Related U.S. Application Data
(60) Provisional application No. 61/079,815, filed on Jul. 11, 2008.

(51) Int. Cl. B25B 9/00

(52) U.S. Cl. 29/268

(57) ABSTRACT

A tool for removing a scrivet having a central shank and a compression sleeve having circumferentially spaced-apart wing elements is provided. The tool includes a first handle and a second handle, a first pair of gripping members configured to grip about the central shank of the scrivet, a second pair of gripping members configured to grip about the base of the scrivet, a first connecting mechanism attached to the first pair of gripping members, and a second connecting mechanism attached to the second pair of gripping members. The tool is configured such that the first pair of gripping members engages the central shank upon a first predetermined amount of movement of the handles and pull the central shank at a second predetermined amount of movement of the handles. A third predetermined movement of the handles causes the second pair of gripping members to grip the base of the scrivet.

### PRIORITY CLAIM

This application claims priority to and hereby incorporates with reference the disclosure of U.S. Provisional Patent Application No. 61/079,815 filed on Jul. 11, 2008.

### TECHNICAL FIELD AND BACKGROUND OF THE INVENTION

This application relates to a scrivet fastener removal tool. Scrivets are fasteners used to fasten two panels together and are typically made of a plastic material. The scrivet base rests against a first panel to be fastened to a second panel and is inserted into an aperture aligned between the two panels. The scrivet consists of a central shank configured to be driven into an expandable compression sleeve formed by circumferentially spaced-apart wing elements connected with a washer shaped base. The compression sleeve is of a smaller diameter than the central pin. The central shank is driven into the compression sleeve thereby causing expansion and holding the second panel against the first panel. In some instances, the scrivet may also include a threaded portion along the central shank for threading the scrivet within the base. The general principle of the scrivet is that the central pin expands the compression sleeve creating an interference contact and holding at least two panels together.

Scrivets are a temporary fastener and are removable from the panels and typically done so with a crowbar, series of screwdrivers, knifes, or the like. The user wedges one of these tools underneath the central shank of the scrivet and between the base and then pries the central shank of the scrivet upwards. In some instances, the scrivet may also be removed by wedging a tool underneath the scrivet base and popping the entire scrivet out. These methods are largely ineffective because the compression sleeve of the scrivet is still under stress as long as the central shank is still driven in, thereby causing interference stresses making removal of the scrivet difficult. Other methods may involve simply drilling the scrivet out. All of these methods are time consuming and may damage the structure surrounding the scrivet. In other instances, the scrivet may be unrecoverable after dislodging the scrivet with a screwdriver or the like and the scrivet is many times destroyed during removal. Scrivets are typically used for automotive and aircraft uses, and, in the instance of aircraft use, foreign object damage or loss of a scrivet within the aircraft can cause serious damage. For automotive uses, the scrivet may incorporate an ornamental design and in these instances, damaging of the scrivet necessitates a replacement scrivet of the exact same design, usually at a substantial cost.

Accordingly there remains a need for a scrivet remover and method for removing scrivets that is safe, time and cost efficient, that leaves the scrivet in an easy to find position, fully intact, and reusable. The present invention was conceived to address these issues.

### SUMMARY OF THE INVENTION

Therefore it is an object of the invention to provide a scrivet remover.

It is another object of the invention to provide a method for removing a scrivet.

It is another object of the invention to provide a scrivet remover that does not damage the scrivet.

It is another object of the invention to provide a scrivet remover that does not cause foreign object damage.

It is another object of the invention to provide a scrivet remover that is quick and efficient to use.

These and other objects of the present invention are achieved in the preferred embodiments disclosed below by providing a tool for removing a scrivet having a central shank and a compression sleeve having circumferentially spaced-apart wing elements. The tool includes a first handle and a second handle, a first pair of gripping members configured to grip about the central shank of the scrivet, a second pair of gripping members configured to grip about the base of the scrivet, a first connecting mechanism attached to the first pair of gripping members, and a second connecting mechanism attached to the second pair of gripping members. The first connecting mechanism is configured such that the first pair of gripping members engages the central shank upon a first predetermined amount of movement of either of the first or the second handles, the first connecting mechanism is configured such that the first pair of gripping members travel linearly upon a second predetermined amount of movement of the first or the second handles and thus impart linear movement to the central shank, the second connecting mechanism is configured to engage the base upon a third predetermined amount of either of the first or second handles.

According to another embodiment of the invention, the first and the second handle are pivotally connected about a medial portion of each of the first and second handles and a torsional spring is provided about a position where the first and second handle are pivotally connected to bias the first and second handle into an open position.

According to another embodiment of the invention, the first pair of gripping members are positioned inside of an area defined by the second pair of gripping members.

According to another embodiment of the invention, the engagement point of the first pair of gripping members is colinear with the engagement point of the second pair of gripping members.

According to another embodiment of the invention, a scrivet remover tool for removing a scrivet of the type having a central shank configured to fit within a compression sleeve defining a peripherally extending base and a plurality of circumferentially spaced-apart wing elements is provided. The tool includes a first and a second handle pivotally connected with one another at a median portion of each of the first and the second handles, a first linkage comprising a first pair of linking members pivotally connected on one end of each linking member of the first pair of linking members to a distal end of the first handle and a second pair of linking members pivotally connected to each other by a first pin positioned at about a medial portion of each linking member of the second pair of linking members, wherein each linking member of the first pair of linking members defines an elongate slot that receives a retaining shoulder extending through an end of each linking member of the second pair of linking members and connecting the first pair of linking members to the second pair of linking members and a second linkage comprising a third pair of linking members pivotally connected on one end of each linking member of the third pair of linking members to a distal end of the first handle and a fourth pair of linking members pivotally connected to each other by a guide pin, each respective linking member of the third pair of linking members being pivotally connected with a respective linking member of the fourth pair of linking members. A connection block is attached to the distal end of the second handle and carrying the first pin that connects each linking member of the second pair of linking members and defining a guide channel that is aligned with and receives the guide pin, thereby allowing longitudinal movement of the guide pin within the guide channel. Scrivet sleeve gripping member are provided and include a pair of mutually engaging hooks formed on an end opposite of the retaining shoulder of the second pair of linking members and adapted for scrivet sleeve engagement upon linear movement of the second pair of linking members. Scrivet shank gripping members are provided and include a pair of mutually engaging hooks formed on an end of the fourth pair of linking members and adapted for scrivet shank movement upon linear movement of the second linkage. The tool is configured such that movement of either of the first or the second handle imparts a linear movement to the second linkage until the scrivet shank gripping members engage a proximally positioned scrivet shank and pull the shank away from the compression sleeve of the scrivet, and subsequent movement of either of the first or the second handle imparts linear movement to the first pair of linking members until the retaining shoulder abuts an end of the elongate slot of the first linking members, thereby imparting movement to the first linkage and causing engagement of the scrivet compression sleeve gripping member against the scrivet compression sleeve and subsequent longitudinal movement of the scrivet.

According to another embodiment of the invention, the tool includes a torsional spring that is provided about a position where the first and second handle are pivotally connected to bias the first and second handle into an open position

According to another embodiment of the invention, the elongate slots of each linking member of the first pair of linking members are about one half of the length of each linking member of the first pair of linking members.

According to another embodiment of the invention, a scrivet remover tool for removing a scrivet of the type having a central shank and a compression sleeve having circumferentially spaced-apart wing elements positioned below a scrivet base is provided. The tool includes a first and a second handle pivotally connected with one another at a median portion of each of the first and the second handles, scrivet shank gripping means for gripping the central shank of a scrivet, scrivet sleeve gripping means for gripping the compression sleeve of a scrivet, a first linking means configured for imparting movement to the scrivet shank gripping means upon a first squeezing of either of the first or second handles to cause the scrivet shank gripping means to grip the central shank of the scrivet and configured to impart linear movement of the gripping means away from the compression sleeve of the scrivet upon a second subsequent squeezing of either of the first or second handles, and a second linking means configured for imparting movement to the scrivet sleeve gripping means upon third subsequent squeezing of either of the first or second handles to cause the scrivet gripping means to grip below the base of the scrivet. The second squeezing of either of the first or second handles causes the central shank of the scrivet to be removed from the compression sleeve, thus alleviating compression forces cause on the circumferentially spaced-apart wing elements.

### BRIEF DESCRIPTION OF THE DRAWINGS

Some of the objects of the invention have been set forth above. Other objects and advantages of the invention will appear as the description of the invention proceeds when taken in conjunction with the following drawings, in which:

FIG. 1 is a side view of a scrivet remover tool in a first open position according to the present invention;

FIG. 2 is a side view of a scrivet remover tool in a second position according to the present invention;

FIG. 3 is side view of a scrivet remover tool in a third position according to the present invention;

FIG. 4 is a side cross-sectional view of a scrivet removal tool in the second position shown in FIG. 1; and

FIG. 5 is a side cross-sectional view of a scrivet removal tool in the third position shown in FIG. 2.

### DESCRIPTION OF THE PREFERRED EMBODIMENTS AND BEST MODE

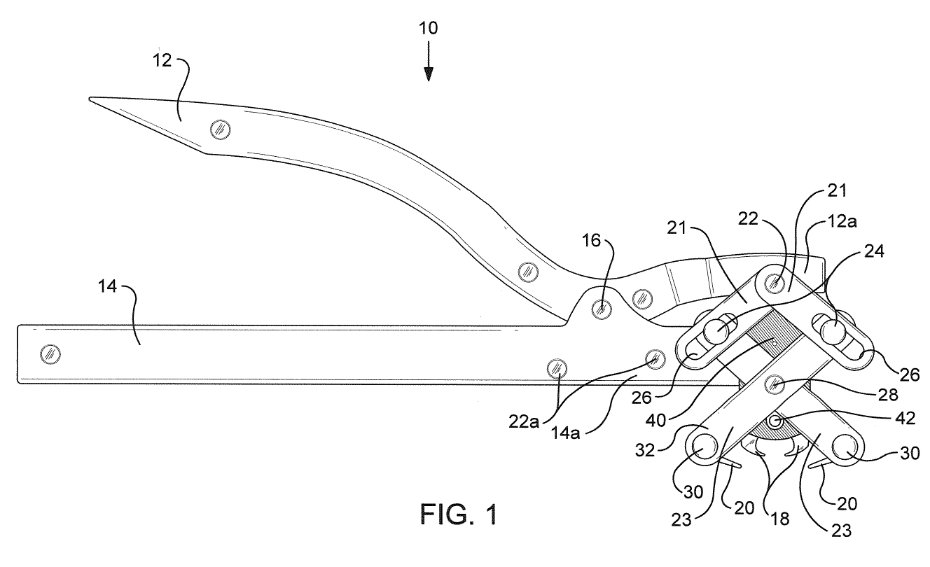

Referring now specifically to the drawings where like elements are represented by like referenced numerals, a scrivet fastener remover tool 10 is generally shown throughout FIGS. 1-5. The tool 10 is formed from a first handle 12 and a second handle 14 forming a pair of handles 12, 14 pivotally connected about a central connection 16. The pair of handles 12, 14 are configured such that upon a mechanical input like squeezing of the handles 12, 14, the pair of handles 12, 14 become closer together on the squeezing end and further apart on distal handle ends 12a and 14a.

The handle 14 is connected to a connection block 40. The connection block 40 remains stationary relative to handle 14 because it is fixed to the distal end 14a of the second handle 14. Handle 12 is attached to a first linkage that includes a plunger 44 pivotally connected to a pair of linking members 45 forming a scissor like connection that is received within connecting block 40 and is pivotally connected with a guide pin 42 that is carried within a guide channel 43 form through the connecting block 40. The pair of linking members 45 are pivotally connected about guide pin 42 in a medial portion of each of the linking members 45. A pair of first gripping members 18 are provided on the lowermost end of each of the linking members 45. These gripping members 20 are adapted for cooperative engagement about the head of a scrivet shank 54.

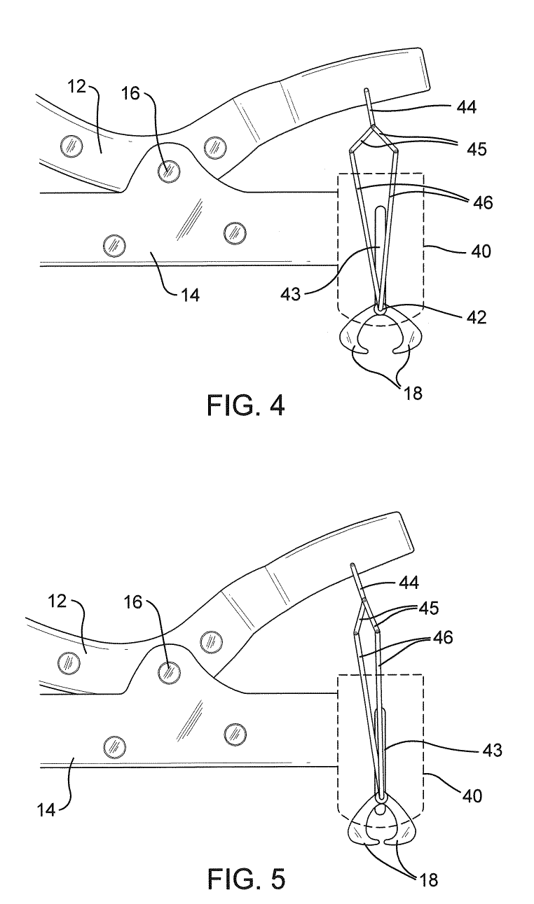

The linking members 45 are configured and designed such that when the first end 12a of the handle 12 moves upwards, the linking members 45 to become more parallel and force a closing action on the first gripping members 20 and subsequent vertical movement of the guide pin 42 and gripping members 18. Further description of the first linkage is found in the discussion accompanying FIGS. 4 and 5.

The handle 12 is attached to a second linkage including a first pair of linking arms 21 about a central pin 22. The linking arms 21 are configured such that they are pivotally connected and capable of rotation about central pin 22. Each linking arm 21 includes an elongate slot 26. A second pair of linking arms 23 are provided and each arm 23 has a retaining shoulder 24 attached at first ends and is configured to be received within the elongate slot 26 of the first pair of linking arms 21. The second pair of linking arms 23 are pivotally connected about a pin 28 that is provided preferably on the connecting block 40, or in some instances, handle 14. At the second ends of the linking arms 23, a second pair of gripping members 20 are provided and are configured to fit underneath a base 56 of the scrivet 50. The second pair of gripping members 20 are attached by a fastener 30.

As shown in FIG. 1 and FIG. 4, the scrivet remover tool 10 is in a first position wherein the handles 12, 14 are biased outward and the connecting mechanisms remain in an open position. A series of torsional or coil springs may be provided at least connection point 16 and bias the tool 10 into the first position. In a preferred embodiment, torsional springs are also positioned about connection 28 in order to bias the gripping members 20 towards a first opened position. In this position, retaining shoulders 24 are positioned medially within elongate slots 26 of arms 21, and gripping members 18, 20 are fully contracted.

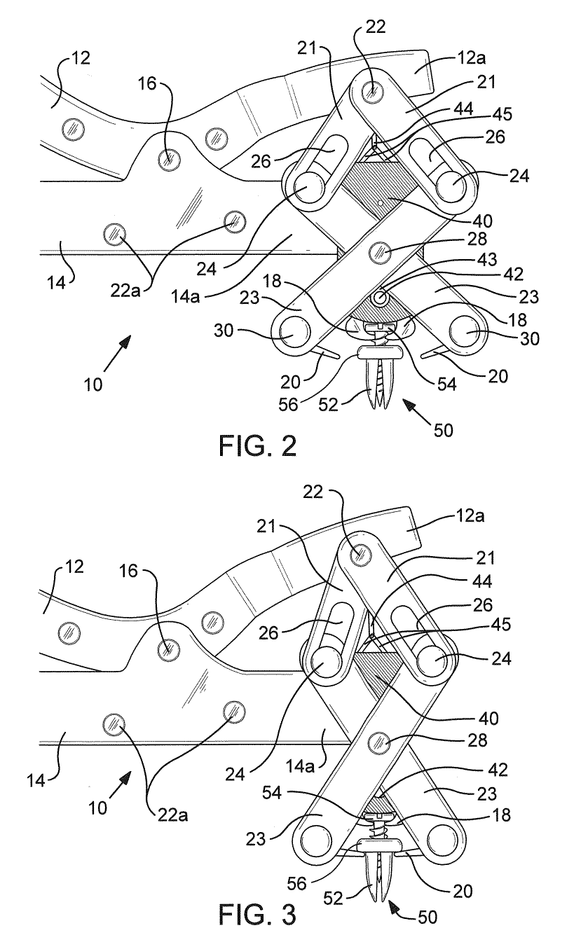

As shown in FIGS. 2 and 5, the tool is in the second position. In this position, the handles 12,14 have been squeezed such that linear movement has been imparted to the levers 21 and 23. Immediately upon squeezing the handles 12, 14, the plunger 44 moves vertically causing the linking members 45 to become more parallel and then subsequently cause gripping members 18 to engage the central shank 54 and then pull guide pin 42 upward within the guide channel 43 of the connection block 40. It is important to note that the arms 21 are also moving upwards, however, they have not imparted any movement to arms 23 yet because retaining shoulder 24 has just reached the end of elongate slots 26. Until retaining shoulder 24 has reached the end of the elongate slots 26, no movement of the arms 23 will occur. In this manner, first gripping members 18 converge towards mutual engagement and then subsequently undergo vertical movement. As shown in FIG. 2 and FIG. 4, the gripping members 18 have yet to undergo any vertical movement as evidenced by retaining shoulder 24 maintaining the same relative position as shown in FIG. 1.

The elongate slots 26 are provided to delay the opening of the second pair of gripping members 20. The retaining shoulder 24 is configured to slide within the elongate slot 26 until the shoulder 24 contacts the linking arms 21 and thus imparts linear movement to the second pair of gripping members 20. In this manner, the elongate slot 26 may be designed to fit scrivets of varying sizes. For a greater delay period, the elongate slots 26 would be increased in length. For a lesser delay period, the elongate slots 26 would be decreased in length. As shown, elongate slots 26 are about half the length of arms 23.

As shown in FIG. 3, the scrivet remover tool 10 is shown in a third position. In this position, the second pair of gripping members 20 are positioned beneath the base 56 of the scrivet 50 after retaining shoulder 24 has contacted the end of the elongate slots 26 and further squeezing movement of handles 12 and 14 has imparted more movement to arms 23 causing them to become more parallel. In this position, the retaining shoulders 24 have been fully extended within the elongate slots 26 such that the second pair of gripping members 20 are moved towards mutual engagement. In this manner, the second pair of gripping members 20 are placed under the scrivet base 52. Further squeezing of the handles 12,14 causes gripping members 18 to undergo additional vertical movement, pulling scrivet shank 54 away from base 52. This should remove the scrivet entirely from the panel, but in some instances, it may be necessary to pull the tool away from the panel surface to facilitate the removal of the entire scrivet 50.

FIGS. 4 and 5 show a cross-sectional view of the first linkage in more detail. The first linkage includes plunger 44, a first pair of linking members 45, and a second pair of linking members 46. Each respective linking member of the first pair of linking members 45 is connected to a respective linking member of the second pair of linking members 46. As shown in FIG. 4, the guide pin 42 is positioned at a lowest point on the guide channel 43. Once handles 12 or 14 are squeezed, linking members 45,46 begin to align in a more parallel orientation causing gripping members 18 to close. Subsequent pulling causes guide pin 42 to travel upwards within guide channel 43 and thus pull the scrivet shank 54 upwards.

A scrivet remover tool is described above. Various details of the invention may be changed without departing from its scope. Furthermore, the foregoing description of the preferred embodiment of the invention and the best mode of practicing the invention are provided for the purpose of illustration only and not for the purpose of limitation.

1. A tool for removing a scrivet having a central shank and a compression sleeve having circumferentially spaced-apart wing elements, the tool comprising:
(a) a first handle and a second handle;
(b) a first pair of gripping members configured to grip about the central shank of the scrivet;
(c) a second pair of gripping members configured to grip about the base of the scrivet;
(d) a first connecting mechanism attached to the first pair of gripping members; and
(e) a second connecting mechanism attached to the second pair of gripping members;
(f) wherein the first connecting mechanism is configured such that the first pair of gripping members engages the central shank upon a first predetermined amount of movement of either of the first or the second handles, the first connecting mechanism is configured such that the first pair of gripping members travel linearly upon a second predetermined amount of movement of the first or the second handles and thus impart linear movement to the central shank, the second connecting mechanism is configured to engage the base upon a third predetermined amount of either of the first or second handles.

2. The tool according to claim 1, wherein the first and the second handle are pivotally connected about a medial portion of each of the first and second handles and a torsional spring is provided about a position where the first and second handle are pivotally connected to bias the first and second handle into an open position.

3. The tool according to claim 1, wherein the first pair of gripping members are positioned inside of an area defined by the second pair of gripping members.

4. The tool according to claim 1, wherein the engagement point of the first pair of gripping members is colinear with the engagement point of the second pair of gripping members.

5. A scrivet remover tool for removing a scrivet of the type having a central shank configured to fit within a compression sleeve defining a peripherally extending base and a plurality of circumferentially spaced-apart wing elements, comprising:
(a) a first and a second handle pivotally connected with one another at a median portion of each of the first and the second handles;
(b) a first linkage comprising a first pair of linking members pivotally connected on one end of each linking member of the first pair of linking members to a distal end of the first handle and a second pair of linking members pivotally connected to each other by a first pin positioned at about a medial portion of each linking member of the second pair of linking members, wherein each linking member of the first pair of linking members defines an elongate slot that receives a retaining shoulder extending through an end of each linking member of the second pair of linking members and connecting the first pair of linking members to the second pair of linking members;
(c) a second linkage comprising a third pair of linking members pivotally connected on one end of each linking member of the third pair of linking members to a distal end of the first handle and a fourth pair of linking members pivotally connected to each other by a guide pin, each respective linking member of the third pair of linking members being pivotally connected with a respective linking member of the fourth pair of linking members;
(d) a connection block attached to the distal end of the second handle and carrying the first pin that connects each linking member of the second pair of linking members and defining a guide channel that is aligned with and receives the guide pin, thereby allowing longitudinal movement of the guide pin within the guide channel; and
(e) a scrivet sleeve gripping member including a pair of mutually engaging hooks formed on an end opposite of the retaining shoulder of the second pair of linking members and adapted for scrivet sleeve engagement upon linear movement of the second pair of linking members;
(f) a scrivet shank gripping member including a pair of mutually engaging hooks formed on an end of the fourth pair of linking members and adapted for scrivet shank movement upon linear movement of the second linkage;
(g) whereby movement of either of the first or the second handle imparts a linear movement to the second linkage until the scrivet shank gripping members engage a proximally positioned scrivet shank and pull the shank away from the compression sleeve of the scrivet, and subsequent movement of either of the first or the second handle imparts linear movement to the first pair of linking members until the retaining shoulder abuts an end of the elongate slot of the first linking members, thereby imparting movement to the first linkage and causing engagement of the scrivet compression sleeve gripping member against the scrivet compression sleeve and subsequent longitudinal movement of the scrivet.

6. The tool according to claim 5, further including a torsional spring that is provided about a position where the first and second handle are pivotally connected to bias the first and second handle into an open position

7. The tool according to claim 5, wherein the elongate slots of each linking member of the first pair of linking members are about one half of the length of each linking member of the first pair of linking members.

8. A scrivet remover tool for removing a scrivet of the type having a central shank and a compression sleeve having circumferentially spaced-apart wing elements positioned below a scrivet base, comprising:
(a) a first and a second handle pivotally connected with one another at a median portion of each of the first and the second handles;
(b) scrivet shank gripping means for gripping the central shank of a scrivet;
(c) scrivet sleeve gripping means for gripping the compression sleeve of a scrivet;
(d) a first linking means configured for imparting movement to the scrivet shank gripping means upon a first squeezing of either of the first or second handles to cause the scrivet shank gripping means to grip the central shank of the scrivet and configured to impart linear movement of the gripping means away from the compression sleeve of the scrivet upon a second subsequent squeezing of either of the first or second handles; and
(e) a second linking means configured for imparting movement to the scrivet sleeve gripping means upon third subsequent squeezing of either of the first or second handles to cause the scrivet gripping means to grip below the base of the scrivet;
(f) whereby the second squeezing of either of the first or second handles causes the central shank of the scrivet to be removed from the compression sleeve, thus alleviating compression forces cause on the circumferentially spaced-apart wing elements.
